(19) United States
(12) Patent Application Publication
(10) Pub. No.: US 2016/0034247 A1
(43) Pub. Date: Feb. 4, 2016

(54) Extending Content Sources

(71) Applicant: Alibaba Group Holding Limited, Grand Cayman (KY)

(72) Inventor: Jie Sun, Hangzhou (CN)

(21) Appl. No.: 14/807,759

(22) Filed: Jul. 23, 2015

(30) Foreign Application Priority Data
Jul. 30, 2014 (CN) 201410369796.8

(51) Int. Cl. G06F 3/16; G05B 15/02

(52) U.S. Cl. CPC G06F 3/165; G05B 15/02

(57) ABSTRACT

Methods and systems for extending content sources associated with a social application. The implementations may include sampling and quantifying audio signals by a computing device. The computing device may encode the sampled and quantified audio signals based on a predetermined encoding rule to generate a digital audio content and may transmit the digital audio content and a user account to a social application server. The computing device may further transmit an instruction to establish a relationship between the user account and a content source ID corresponding to the digital audio content and may receive, from the social application server, information associated with the established relationship between the user account and the content source ID. This greatly eliminates the need for cumbersome operations for users to extend content sources, and therefore improves convenience.

### CROSS REFERENCE TO RELATED PATENT APPLICATIONS

This application claims priority to Chinese Patent Application No. 201410369796.8, filed on Jul. 30, 2014, entitled “Methods and Systems for Extending Content Sources and Client Terminal as well as Server thereof,” which is hereby incorporated by reference in its entirety.

### TECHNICAL FIELD

Implementations herein relate to a social application technology, and particularly relate to methods and systems for extending content sources.

### BACKGROUND

With the rise in recent years of social applications, users can easily complete social function using mobile phones, tablet PCs and other mobile devices. Examples of the social applications include WECHAT™, LAIWANG™, WEIBO™, YIXING™, FACEBOOK™, TWITTER™, and LINE™.

At first, the users install a social application on their devices. Without presetting a certain function, the social application may merely include certain content sources, which provide public information instead of personal. Some content sources may include public service channels, systems recommended communities, and celebrities. In order to take advantage of the social application, users may add friends through a variety of methods. For example, the social application may search friends in their contacts and emails.

The social application may extend content sources by searching key words. To determine whether it is a personal friend or a public account, users are required to click appropriate buttons of the social application to find and/or add friends to their personal accounts. For example, a WECHAT® user can click “Plus Sign” to set search keywords and to perform searches using a set number of keywords. And then the users select “Add Account” to add the identified account number. Similarly, a LAIWANG® user may use the “Getting Together” function to find and add friends. Other forms of communications, such as online chatting, dating tools, etc., may also be used to find and to add friends. However, it has been found that users are invariably required to perform multiple complex operations to add friends.

### SUMMARY

Implementations herein relate to methods and systems for extending content sources, for example, to improve convenience of extending content sources. To solve the described technical problems above, methods and systems for extending the content sources are implemented using a client terminal and/or a server. This Summary is not intended to identify all key features or essential features of the claimed subject matter, nor is it intended to be used alone as an aid in determining the scope of the claimed subject matter.

In implementations, a method for extending content sources associated with a social application includes sampling and quantifying audio signals by a computing device (e.g., a client terminal). The computing device may further encode the sampled and quantified audio signals based on a predetermined encoding rule to generate a digital audio content. The computing device may transmit the digital audio content and a user account to a social application server and then transmit an instruction to establish a relationship between the user account and a content source identifier (ID) corresponding to the digital audio content. The computing device may receive, from the social application server, information associated with the established relationship between the user account and the content source ID.

In implementations, a method for extending content sources associated with a social application includes receiving, by a computing device (e.g., a server), a digital audio content and a user account associated with the client terminal. The computing device may match the received digital audio content with a stored digital audio content. In response to a determination that the received digital audio content matches the stored digital audio content, the computing device may establish a relationship between the user account associated with the client terminal and the content source ID corresponding to the stored digital audio content based on a predetermined correspondence between the stored digital content and a content source ID.

In implementations, a method for extending content sources associated with a social application may include sampling, by a computing device (e.g., a client terminal) audio signals. The computing device may further retrieve a feature from the audio signals, transmit the feature and a user account to a social application server, and transmit an instruction to establish a relationship between the user account and a content source ID corresponding to the digital audio content. The computing device may receive, from the social application server, information associated with the established relationship between the user account and the content source ID of the feature.

In implementations, a method for extending content sources associated with a social application include receiving, by a computing device (e.g., a server), a feature and a user account associated with the client terminal. The computing device may determine the content source ID corresponding to the feature based on a mapping relationship between a stored feature and a content source ID. The computing device may establish a relationship between the user account associated with the client terminal and the content source ID.

In implementations, a method for extending content sources associated with a social application includes collecting modulated audio signals based on a content source ID of a content source side by a computing device (e.g., a client terminal). The computing device may demodulate the collected audio signals to obtain the content source ID based on a predetermined rule and transmitting the content source ID and a user account to a social application server. The computing device may receive, from the social application server, information associated with the established relationship between the user account and the content source ID.

In implementations, a method for extending content sources associated with a social application includes modulating a content source ID to obtain audio signals based on a predetermined rule and transmitting the audio signals.

In implementations, a system for extending content sources associated with a social application includes a client terminal configured to sample and quantify audio signals, encode the sampled and quantified audio signals based on a predetermined encoding rule to generate a digital audio content, and to transmit the digital audio content and a user account to a social application server. The client terminal may further transmit an instruction to establish a relationship between the user account and a content source ID corresponding to the digital audio content and may receive, from the social application server, information associated with the established relationship between the user account and the content source ID.

The system may further include a social application server configured to receive, from the client terminal, a digital audio content and a user account associated with the client terminal and to match the received digital audio content with a stored digital audio content. In response to a determination that the received digital audio content matches the stored digital audio content, the social application server may establish a relationship between the user account associated with the client terminal and the content source ID corresponding to the stored digital audio content based on a predetermined correspondence between the stored digital content and a content source ID.

In implementations, a client terminal includes a sampling and quantifying module configured to sample and quantify audio signals, and an encoding module configured to encode the sampled and quantified audio signals based on a predetermined encoding rule to generate a digital audio content. The client terminal may further include a transmitting module configured to transmit the digital audio content and a user account to a social application server and to transmit an instruction to establish a relationship between the user account and a content source ID corresponding to the digital audio content. The client terminal may further include a receiving module configured to receive, from the social application server, information associated with the established relationship between the user account and the content source ID.

In implementations, a server includes a receiving module configured to receive, from a client terminal, a digital audio content and a user account associated with the client terminal, and a reading module configured to match the received digital audio content with a stored digital audio content. In response to a determination that the received digital audio content matches the stored digital audio content, the reading module may establish a relationship between the user account associated with the client terminal and the content source ID corresponding to the stored digital audio content based on a predetermined correspondence between the stored digital content and a content source ID.

In implementations, a system for extending content sources associated with a social application includes a client terminal configured to sample audio signals, to retrieve a feature from the audio signals and to transmit the feature and a user account to a social application server. The client terminal may further transmit an instruction to establish a relationship between the user account and a content source ID corresponding to the digital audio content and may receive, from the social application server, information associated with the established relationship between the user account and the content source ID of the feature.

The system may further include a social application server configured to receive, from a client terminal, a feature and a user account associated with the client terminal. The social application server may further determine the content source ID corresponding to the feature and establish a relationship between the user account associated with the client terminal and the content source ID based on a mapping relationship between a stored feature and a content source ID.

In implementations, a client terminal includes a collecting module configured to sample audio signals, and a retrieving module configured to retrieve a feature from the audio signals. The client terminal may further include a transmitting module configured to transmit the feature and a user account to a social application server and to transmit an instruction to establish a relationship between the user account and a content source ID corresponding to the digital audio content. The client terminal may further include a receiving module configured to receive, from the social application server, information associated with the established relationship between the user account and the content source ID of the feature.

In implementations, a server includes a receiving module configured to receive, from a client terminal, a feature and a user account associated with the client terminal, and a determining module configured to determine the content source ID corresponding to the feature based on a mapping relationship between a stored feature and a content source ID. The server may further include a relationship module configured to establish a relationship between the user account associated with the client terminal and the content source ID.

In implementations, a system for extending content sources associated with a social application includes a second client terminal configured to collect modulated audio signals based on a content source ID of a content source side and to demodulate the collected audio signals to obtain the content source ID based on a predetermined rule. The second client terminal may further transmit the content source ID and a user account to a social application server, and may receive, from the social application server, information associated with the established relationship between the user account of the second terminal client and the content source ID.

The system may further include a first client terminal configured to modulate a content source ID to obtain audio signals based on a predetermined rule and to transmit the modulated audio signals.

In implementations, a client terminal may include a collecting module configured to collect modulated audio signals based on a content source ID of a content source side, and a recovering module configured to demodulate the collected audio signals to obtain the content source ID based on a predetermined rule. The client terminal may further include a transmitting module configured to transmit the content source ID and a user account to a social application server, and a receiving module configured to receive, from the social application server, information associated with the established relationship between the user account and the content source ID.

In implementations, a client terminal includes a converting module configured to modulate a content source ID to obtain audio signals based on a predetermined rule, and a transmitting module configured to transmitting the audio signals.

Implementations herein demonstrate that client-specific functions including extending content sources may be implemented by clicking a button of mobile social software. This greatly eliminates the need for cumbersome user operations, and therefore improves convenience.

### BRIEF DESCRIPTION OF THE DRAWINGS

The Detailed Description is described with reference to the accompanying figures. The use of the same reference numbers in different figures indicates similar or identical items.

FIG. 1 is a flow chart of an illustrative process for extending content sources.

FIG. 2 is another flow chart of an illustrative process for extending content sources.

FIG. 3 is yet another flow chart of an illustrative process for extending content sources.

FIG. 4 is yet another flow chart of an illustrative process for extending content sources.

FIG. 5 is yet another flow chart of an illustrative process for extending content sources.

FIG. 6 is yet another flow chart of an illustrative process for extending content sources.

FIG. 7 is a schematic diagram of illustrative computing architecture that enables extending content sources.

FIG. 8 is a schematic diagram of illustrative computing architecture that enables extending content sources on a client terminal.

FIG. 9 is a schematic diagram of illustrative computing architecture that enables extending content sources on a server terminal.

FIG. 10 is another schematic diagram of illustrative computing architecture that enables extending content sources on a client terminal.

FIG. 11 is another schematic diagram of illustrative computing architecture that enables extending content sources on a server terminal.

FIG. 12 is another schematic diagram of illustrative computing architecture that enables extending content sources.

FIG. 13 is yet another schematic diagram of illustrative computing architecture that enables extending content sources on a client terminal.

FIG. 14 is yet another schematic diagram of illustrative computing architecture that enables extending content sources on a client terminal.

### DETAILED DESCRIPTION

Implementations herein relate to methods and systems for extending content sources. In order to enable those of ordinary skill to better understand the present disclosure of technical solutions, the following detailed is provided in conjunction with the drawings. Obviously, the described implementations are merely a part of the implementations of the present disclosure, but not all implementations. Based on the implementations of the present disclosure, those of ordinary skill in making all other implementations without creative effort should belong to the scope of the present disclosure.

Account information and content source IDs are generally stored on a social application server. When users log in to their accounts on a mobile terminal or other terminals, the social application server may send to the terminals the newest content corresponding to the content source IDs. Alternatively, the social application server may push the latest content of the content source IDs to the client terminal using a push mechanism.

In implementations, a social application server may receive a preset of content sources to expand the content sources using a mobile terminal or other terminals. For example, digital audio contents of a content source may be stored on the social application server. Content source IDS may be transmitted from a content source side to the social application server. The social application server may generate the digital audio contents relating to the content source IDS based on a preset modulation rule. For example, if the content source is a radio station, analog signals of the song of the radio station may be sampled, quantified, and/or encoded by a computing device to generate digital audio signals. These digital audio signals may be stored in the social application server. The song of the radio station is generally representative of the station or to highlight the characteristics of voice, melody, songs of the station. In implementations, the analog audio signals may be sampled by the computing device on a time axis based on a certain sampling rate.

The computing device may then quantify amplitude-stratified samples and encode the samples. Encoding may be implemented by various rules such as Pulse Code Modulation or PCM coding types, as specified in the International Telecommunication Union (ITU), “u” or “a” rate of PCM of voice compression standard G.711, adaptive differential pulse code modulation (ADPCM), and Adaptive Delta Modulation ADM). Further, encoding parameters may be used according to audio signals generated by a mathematical model. Encoding feature parameters may be retrieved before encoding, such as using codebook excitation vocoder including G.729, G.723.3 and Code Excited Linear Prediction (CELP) speech coding, and the US Federal Standard (FS-1016) for encoding. Encoding rules may be a linear predictive coding (LPC) type. Standard predictive coding or transform coding, sub-band coding, statistical coding or the like may be implemented in line with G.728, G.729, G.723.1. This application is not limited to these methods.

In implementations, the social application servers may store a correspondence relationship between the digitalized audio signals and the content source ID.

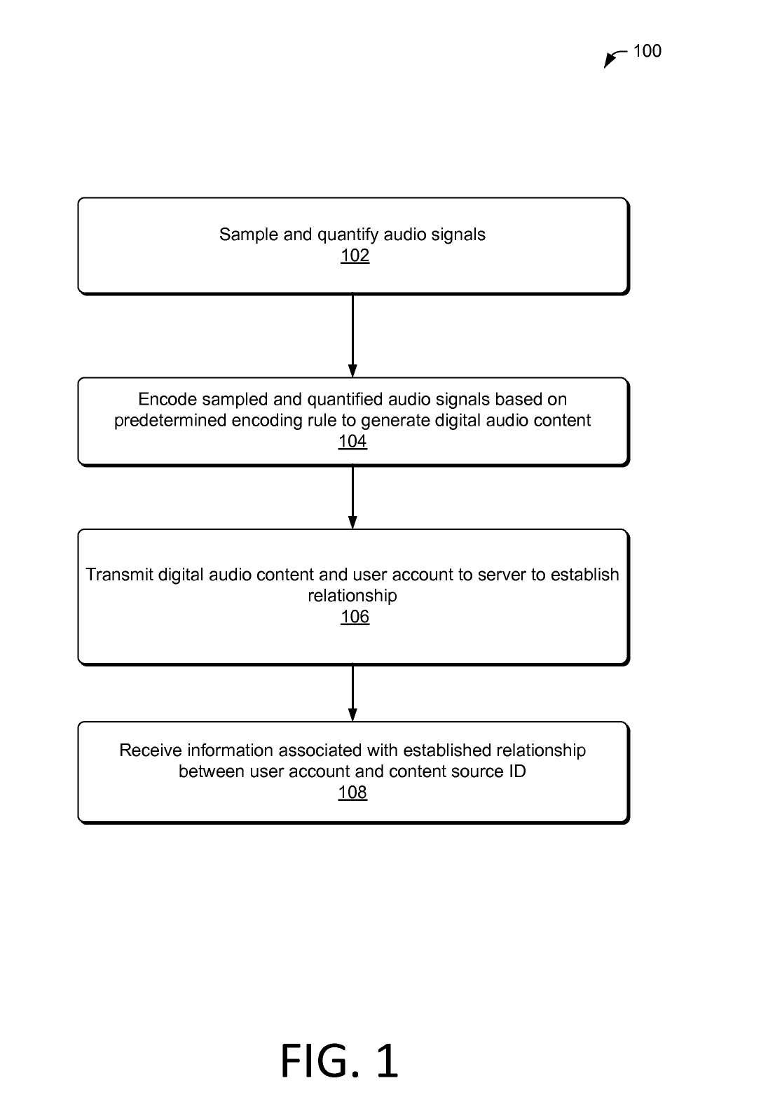

FIG. 1 is a flow chart of an illustrative process 100 for extending content sources. The operations herein may be implemented by a computing device such as mobile terminal or other terminals installed social networking applications. Here, for simplicity, a client terminal may include mobile terminal or other terminals installed social networking applications. A third-party player can play audio files, such as a radio station song, to the client terminals. The third-party player needs audio hardware, such as a speaker. For example, using the speaker, electrical energy may be converted into sound energy to therefore play the audio file.

The client terminal can start a specific function, for example, a touch of a virtual button or a physical button to enable a specific function. This specific function may be performed to collect audio signals as described below.

At 102, the computing device (e.g., a client terminal) may sample and quantify audio signals. As described, a function on the client terminal may be enabled to collect audio signals around with the support of the hardware on the client. For example, a microphone or other acoustic sensors can capture sound waves within hearing range of most people. More sensitive sound sensor can capture sound waves beyond the range of human hearing frequency.

These audio signals generally are continuous analog audio signals with a certain amplitude during a time period. The computing device may sample the audio signals with a predetermined band of the audio signal, and the predetermined band is between 20 Hz to 20 kHz.

In implementations, sampling the audio signals may include sampling and quantifying the audio signals. For example, the client terminal may sample and quantify audio signals via a microphone on the client terminal. Sampling and quantifying processes may digitize continuous analog audio signals in a time axis and an amplitude axis with respect to the original acquisition time.

At 104, the computing device may encode the sampled and quantified audio signals based on a predetermined encoding rule to generate a digital audio content. For example, the Client terminal may encode the sampled and quantified audio signals based on a predetermined encoding rule. By sampling, quantified data may be encoded and/or recorded in a predetermined format. The client terminal may compress the data using an algorithm. For example, a waveform coding, parametric coding (source code) or mixed coding method may be implemented. Waveform coding generally converts waveform signals after sampling, qualifying, and encoding to digital signals.

Parametric coding generally determines feature parameters of characteristic speech based on a pronunciation mechanism of sounds and encodes the feature parameters. A mixed coding method is an encoding method, which combines the advantages of waveform coding and parametric coding. For example, the client terminal may encode the sampled and quantified audio signals based on a predetermined encoding rule to generate digital audio contents. The client terminal may use an encoding rule to encode audio signals. The audio signals stored on the social application server may be processed using the same encoding rule.

At 106, the computing device may transmit the digital audio content and a user account to a social application server, and transmit an instruction to establish a relationship between the user account and a content source ID corresponding to the digital audio content.

In addition to the digital audio content, the client terminal may also transfer the user account to the social application server, and transmit an instruction to establish a relationship between the user account and a content source ID corresponding to the digital audio content.

In implementations, account information and content source IDs are generally stored on the social application server. The user account needs to maintain correspondence with the user's content source ID. There is a corresponding relationship between the digital audio content and content sources. In this way, the digital audio content can be used to associate, in the subsequent steps, the user account with the desired expansion of content sources. Therefore the content sources may be extended.

For example, after receiving the digital audio content from the client terminal, the social application server may match the received digital audio content with a stored digital audio content. In response to a determination that the received digital audio content matches the stored digital audio content, the social application server may add the content source ID of the digital audio content to the content sources associated with the user account of the client terminal.

In implementations, the social application server may transmit information associated with the established relationship between the user account and the content source ID to the client terminal. Because sampled and quantified actual audio signals are short, it is difficult to compare the actual audio signals to the stored audio content on the social application server.

In implementations, the client terminal may sample and quantify the audio content, which is longer than a first predetermined period of time. For example, after receiving the digital audio content from the client terminal, the social application server may match the received digital audio content with a stored digital audio content.

The generated encoded digital audio content corresponds to audio signals sampled and qualified by the client terminal within a time range. This time range may be different from the length of the stored audio content on the social application server. Therefore, comparison modes for sampled and quantified audio signals and the stored audio signals are not limited to overall comparisons but may be extended to comparisons of mathematical sets. For example, the social application server may determine that the received digital audio content matches the stored digital audio content when the received digital audio content is a subset of the stored digital audio content. Thus, when the stored digital audio content on the social application server is, for example, 10 second fragments. The sampled and quantified digital audio content is considered as a subset of the stored digital audio content if the sampled and quantified digital audio content is a portion of the 10 seconds fragments (e.g., 5 seconds fragments). In other words, if the sampled and quantified digital audio content (5 seconds fragments) is a portion of the stored digital audio content (10 seconds fragments), the social application server may determine that these two contents match.

In implementations, after receiving the digital audio content from the client terminal, the social application server may match a proper subset of the received digital audio content with the stored digital audio content. The social application server may determine that the received digital audio content matches the stored digital audio content when the proper subset is a subset of the stored digital audio content. Thus, the impact caused by some of the other signals sampled and quantified by the client terminal may be avoided.

For example, the stored digital audio content on the social application server is “AABCCDEDF,” the sampled and quantified digital audio content is “EBCCDEDN,” and a proper subset of the stored digital audio content may be “BCCDED.” The proper subset is a subset of “AABCCDEDF,” and therefore the social application server may determine that the stored digital audio content matches with the sampled and quantified digital audio content. In this way, the client terminal can effectively avoid interference caused by equipment or surrounding environment when enabling and/or disabling the collecting function of the client terminal. In these instances, the proper subset of the encoded digital audio content represents the encoded digital audio content to avoid matching errors.

The client terminal may sample and quantify the audio content that is longer than a first predetermined period of time. In implementations, a third party organization may playback looped audios. In some instances, the sampled and quantified digital audio content may be different from the stored digital audio content on the social application server. The sampled and quantified digital audio content may be a portion of the looped audio. In these instances, the social application may consider the looped playback of the digital audio content.

In implementations, the social application server may determine that the received digital audio content matches the stored digital audio content when the received digital audio content is a subset of the stored digital audio content that includes the looped digital audio content. For example, the encoded digital audio content received by the social application server is “EDFAABCCDED.” If the looped digital audio content is “AABCCDEDFAABCCDEDF . . . AABCCDEDF” (e.g., 5 loops of “AABCCDEDF”), the social application server may determine that these two contents match.

At 108, the computing device may receive information associated with the established relationship between the user account and the content source ID. The social application server may transmit the information associated with the established relationship between the user account and the content source ID.

The social application server may add the content source ID of the digital audio content to the content sources associated with the user account of the client terminal. Further, the social application server may transmit the information associated with the established relationship between the user account and the content source ID to the client terminal. Accordingly, the client terminal may receive, from the social application server, the information associated with the established relationship between the user account and the content source ID and may add the content source ID. The content source ID may include a personal user account, a public service party service provider account, or a business account.

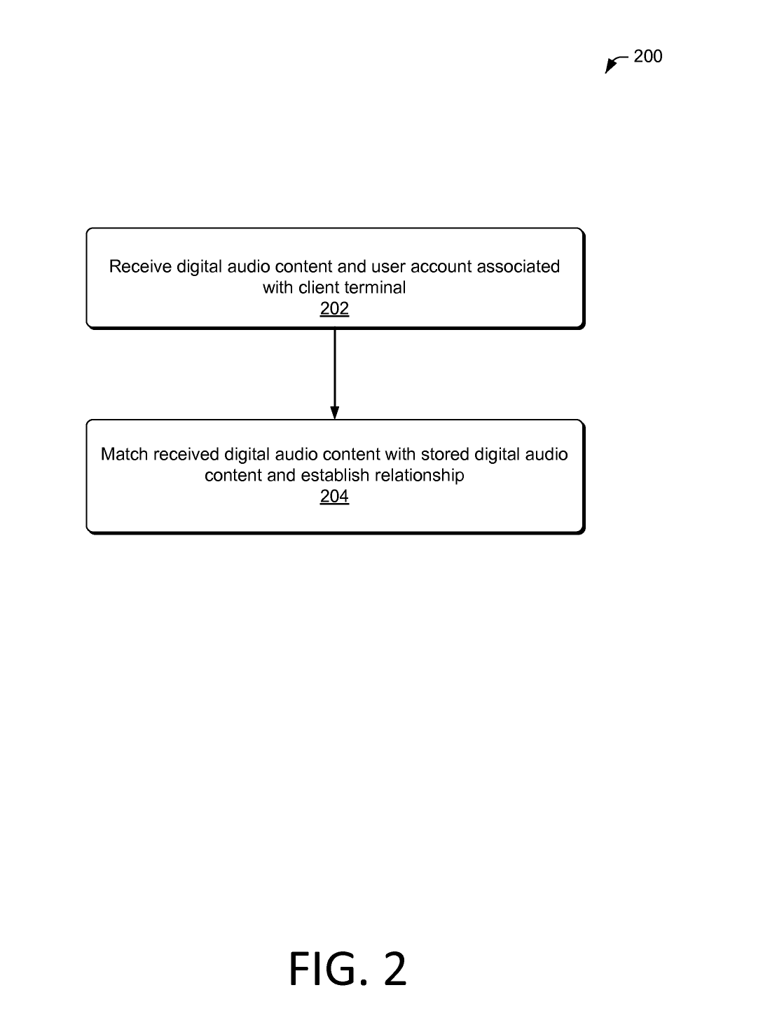

FIG. 2 is a flow chart of an illustrative process 200 for extending content sources. At 202, a social application server may receive, from a client terminal, a digital audio content and a user account associated with the client terminal.

At 204, the social application server may match the received digital audio content with a stored digital audio content. In response to a determination that the received digital audio content matches the stored digital audio content, the social application server may establish a relationship between the user account associated with the client terminal and the content source ID corresponding to the stored digital audio content based on a predetermined correspondence between the stored digital content and a content source ID.

In implementation, the social application server may determine that the received digital audio content matches the stored digital audio content when the received digital audio content is a subset of the stored digital audio content. For example, the social application server may determine that the received digital audio content matches the stored digital audio content when the received digital audio content is a subset of the stored digital audio content. The social application server may determine that the received digital audio content matches the stored digital audio content when a proper subset of the received digital audio content is the subset of the stored digital audio content. A length of the proper subset is not less than a predetermined length.

In implementations, the social application server may determine that the received digital audio content matches the stored digital audio content when the received digital audio content is a subset of the stored looped digital audio content. The social application server may determine that the received digital audio content matches the stored digital audio content when the received digital audio content is a subset of the stored looped digital audio content, and store the digital audio content and the content source ID at the social application server.

The stored digital audio content may include the digital audio content that is received by the social application server and is modulated based on a predetermined rule. The social application server may add the content source ID corresponding to the digital audio content to a social relationship list of a social account at the client terminal. For example, the social application server may establish a relationship between the user account associated with the client terminal and the content source ID corresponding to the stored digital audio content.

Through the implementations, a user on the client terminal may not need complex operations to extend content sources. After enabling the described function, the user may complete most of the operations for extension of content sources. This improves convenience for the user to extending content sources.

In implementations, the social application server may receive a preset of the content sources to expend the content sources using a mobile terminal or other terminals. For example, the content source may store a feature of digital audio contents on social application servers. The feature may include a feature of a time domain or a frequency domain of the audio signals, or a combination thereof. For example, the radio station may store a retrieved feature of a time domain and/or a frequency domain of the station song on the social application server.

In implementations, the social application servers may store a correspondence relationship between the digitalized audio signals and the content source ID.

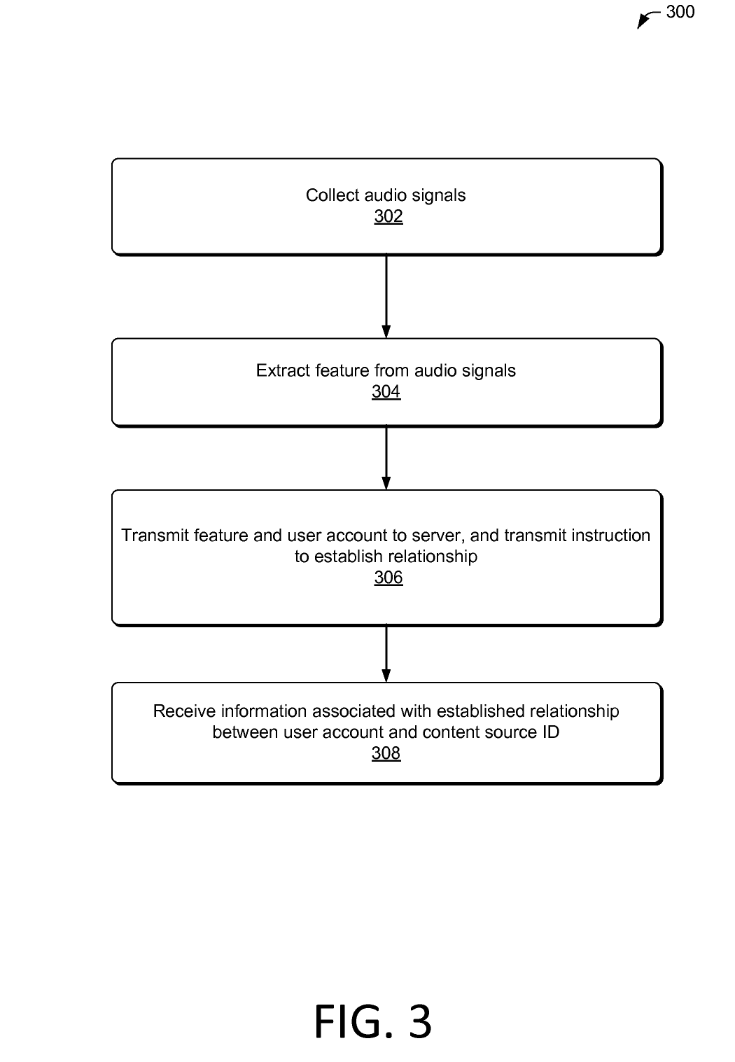

FIG. 3 is a flow chart of an illustrative process 300 for extending content sources. Operations of process 300 may be implemented by a computing device such as mobile terminal or other terminals installed social networking applications.

At 302, the computing device may sample and/or collect audio signals. As described, a function on the client terminal may be enabled to collect audio signals around with the support of the hardware on the client. For example, a microphone or other acoustic sensors can capture sound waves within hearing range of most people. More sensitive sound sensor can capture beyond the range of human hearing frequency sound waves. The client terminal may sample and quantify audio signals via a microphone on the client terminal. Examples of the audio signal acquisition may include the use of analog-to-digital converter (A/D) hardware to sample and quantify analog audio signals.

At 304, the computing device may retrieve or extract a feature from the audio signals. The feature may include a feature of a time domain or a frequency domain of the audio signals, or a combination thereof. After obtaining the digital audio signal, the client terminal may use signal processing and pattern recognition technology to retrieve various elements of music features such as treble, bass, alto, drums, melody, rhythm and so on. Specific methods may include time domain and frequency domain related methods. Music beats of the time domain feature are mainly manifested in WAVE waveform files: physical characteristics of the wave file. For a strong sense of rhythm dance (such as slow three, four and so slow), time-domain characteristics may be obtained by calculating an autocorrelation function to measure the fundamental frequency of drums. Treble, bass, alto, drums and others may be identified and obtained via the frequency domain of songs. The specific method is generally carried out by short-time Fourier transform spectrum transform. The energy of signals may be calculated based on the signal power spectral density. Whether there is a signal is determined based on the characteristics of music signals and a preset certain threshold.

Extracted feature information generally corresponds to extracted audio signal. For example, with respect to a time domain or frequency domain, an amplitude of male voice is greater than an amplitude of female voice; while a frequency of female voice is higher than a frequency of male voice. This is because loudness corresponds to magnitudes of the vibrations while tones correspond to the frequency of the vibrations. A male voice is generally deep and vigorous, while a female voice is generally sonorous. Similarly, melodic features and/or features from extracted beats generally correspond to extracted digitized audio signals.

At 306, the computing device may transmit the feature and a user account to a social application server, and transmit an instruction to establish a relationship between the user account and a content source ID corresponding to the digital audio content. For example, the social application server may receive the feature from the client terminal. The social application server may determine whether the content source ID corresponding to the feature based on a mapping relationship between a stored feature and a content source ID. The stored feature is generated based on the content source ID that is received by the social application server from the content source side and is modulated based on a predetermined rule.

The social application server may establish a relationship between the user account associated with the client terminal and the content source ID. The social application server may store the relationship between the stored feature and the content source ID at the social application server. For example, the social application server may add the content source ID corresponding to the feature to a social relationship list of a social account at the client terminal. The social application server may establish a relationship between the user account associated with the client terminal and the content source ID corresponding to the stored feature.

At 308, the computing device may receive, from the social application server, information associated with the established relationship between the user account and the content source ID of the feature. The social application server may add the content source ID of the digital audio content to the content sources associated with the user account of the client terminal. Further, the social application server may transmit information associated with the established relationship between the user account and the content source ID to the client terminal.

The client terminal may receive, from the social application server, the information associated with the established relationship between the user account and the content source ID. Thus, the client may add the content source ID accordingly. The content source ID may include a personal user account, a public service party service provider account, or a business account.

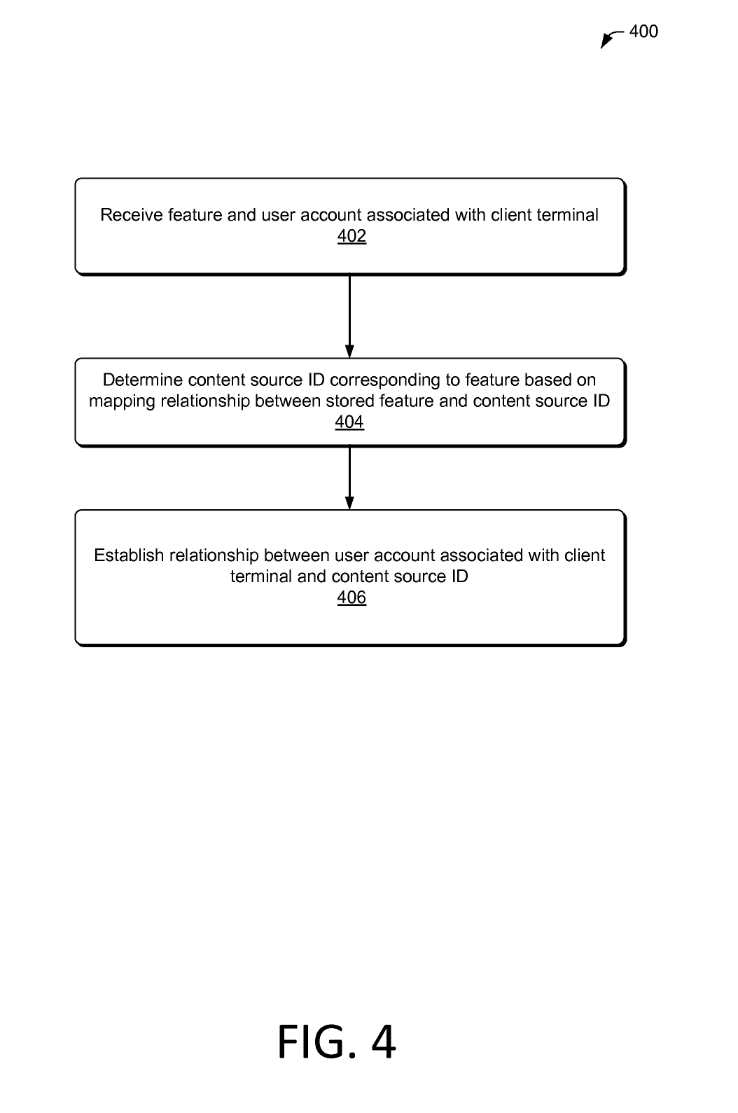

FIG. 4 is a flow chart of an illustrative process 400 for extending content sources. At 402, the social application server may receive, from a client terminal, a feature and a user account associated with the client terminal.

At 404, the social application server may determine the content source ID corresponding to the feature based on a mapping relationship between a stored feature and a content source ID. In implementations, the stored feature is generated based on the received digital audio content from the content source side. For example, digital audio contents of a content source may be stored on social application servers. The digital audio content may include a station song if the content source side is a radio station. For example, after receiving the digital audio content from the client terminal, the social application server may match the received digital audio content with the stored digital audio content.

In implementations, the social application server may establish a relationship between the user account and a content source ID corresponding to the digital audio content. The feature may include a feature of a time domain or a frequency domain of the audio signals, or a combination thereof.

After obtaining the digital audio signal, the client terminal may use signal processing and pattern recognition technology to retrieve various elements of music features such as treble, bass, alto, drums, melody, rhythm and so on. Specific methods may include a time domain and a frequency domain, as described previously. For example, after receiving the digital audio content from the client terminal, the social application server may match the received digital audio content with a stored digital audio content. Based on a mapping relationship between the feature and the content source ID, the social application server may determine the content source ID.

At 406, the social application server may establish a relationship between the user account associated with the client terminal and the content source ID. In response to a determination that the received digital audio content matches the stored digital audio content, the social application server may add the content source ID of the digital audio content to the content sources associated with the user account of the client terminal. In implementations, the social application server may transmit information associated with the established relationship between the user account and the content source ID to the client terminal.

Accordingly, a user on the client terminal may not need complex operations to extend content sources. After enabling the described function, the user may complete most of the operations. This improves convenience of extending content sources.

As illustrated in FIGS. 1 to 4, the client terminal may be located in a traveling vehicle having a third-party player agency broadcasting the audio signals. The driver may avoid complex operations to extend content sources. For example, the driver is driving a car while listening to a radio.

In implementations, radio stations broadcast programs using a higher frequency (not affecting the normal play) to play a particular signal. A user may open the social application and enable a function of the social application. Then, the client terminal may sample and quantify audio signals via a microphone on the client terminal. The client terminal may obtain encoded audio signals and/or retrieve a feature from the program broadcaster by the radio station. Further, the client terminal may transmit the digital audio content and/or the retrieved features as well as a user account to a social application server,

The social application server may store the digital audio content and/or the feature. Further, the social application servers may store a correspondence relationship between the digitalized audio signals and the content source ID. For example, after receiving the digital audio content from the client terminal, the social application server may match the received digital audio content with a stored digital audio content. The social application server may add the content source ID of the digital audio content to the content sources associated with the user account of the client terminal. The client terminal may receive, from the social application server, information associated with the established relationship between the user account and the content source ID. The client terminal may add the radio station as a new content source and listen to a program of the radio station in the future.

The implementations herein allow the user to enable one or more client-specific functions to extend content sources. This greatly eliminates the need for cumbersome user operations, and therefore improves convenience. This is particularly important for a driver in driving a vehicle.

In implementations, operations may be performed by one or more client terminals (e.g., a first client terminal and a second client terminal). For example, a first client terminal may be a content source. The first client terminal may map a content source ID using a predetermined mapping rules into audio signals and transmit the audio signals to a computing device (e.g., another client terminal or a server). The first client terminal may convert the content source ID to a certain audio signals.

In implementations, the conversion may be implemented using a predetermined mapping rule. For example, each character corresponds to a unique ASCII code. Each ASCII code may correspond to a combination of a certain number of frequency bands, and each frequency segment has a predetermined length of time. For example, an ASCII code “4EBA” corresponds to a Chinese character “person”. According to the above rules, the ASCII code may correspond to: the core frequency of 50 HZ, duration of 50 ms frequency band a, the core frequency of 165 HZ, duration of 50 ms frequency band b, the core frequency of 2.34 KHZ, duration of 50 ms frequency band c, the core frequency of 19 KHZ, duration of 50 ms frequency band d. A combination of frequency bands a-d represents the ASCII code “4EBA.” The combination also corresponds to one Chinese character. Accordingly, the first client terminal may convert the content source ID to a certain audio signals.

The content source ID may be an account associated with the first client terminal or an account associated with other content sources. The content source ID may include at least one of a personal user account, a public service party service provider account, or a business account. The client first terminal may broadcast the mapped audio signals via speakers.

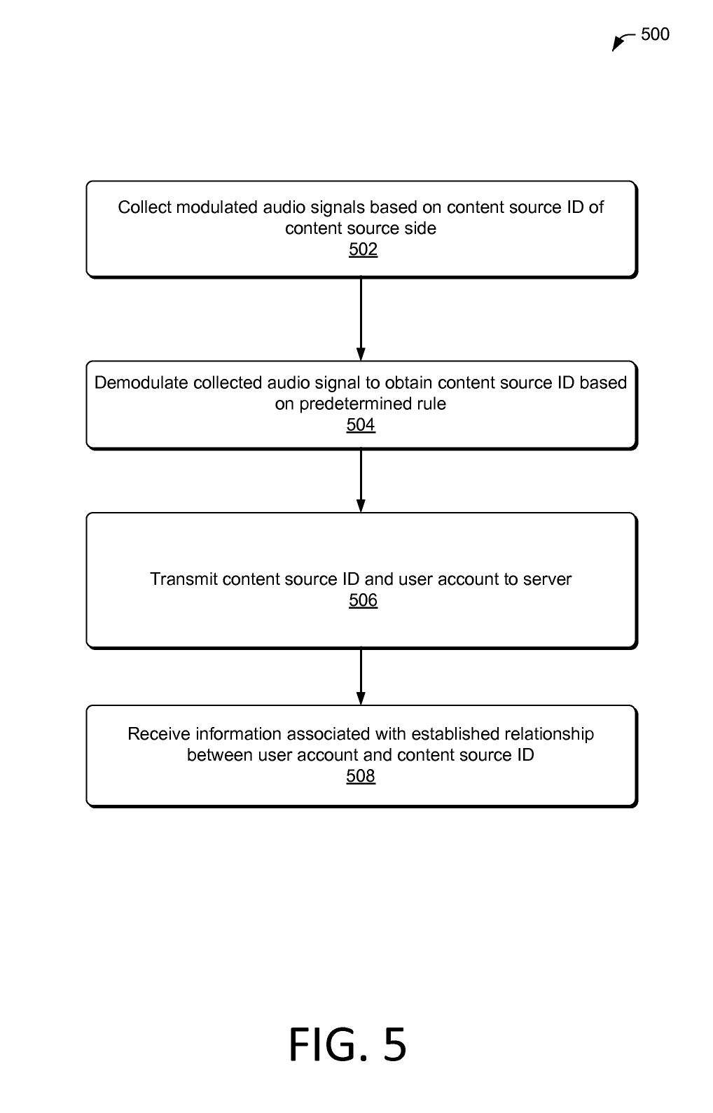

FIG. 5 is a flow chart of an illustrative process 500 for extending content sources. At 502, a second client terminal may collect modulated audio signals based on a content source ID of a content source side. The second client terminal may capture the audio signals using a microphone from the first client terminal.

At 504, the second client terminal may demodulate the collected audio signals to obtain the content source ID based on a predetermined rule. Based on the predetermined rule used by the first client terminal during the conversion of the audio signals, the second client terminal may demodulate the collected audio signals to obtain the content source ID. For example, the received audio signal may be sampled at a frequency of 200 KHz. So basically the second client terminal may restore the audio signal at the frequency of 50 ms in a long duration. Further, the second client terminal may demodulate the collected audio signals to obtain an ASCII code based on the predetermined rule. For example, the second client terminal may obtain a string using the ASCII code and restore the content source ID.

At 506, the second client terminal may transmit the content source ID and a user account to a social application server. The social application server may add the content source ID of the digital audio content to the content sources associated with the user account of the client terminal. Further, the social application server may transmit information associated with the established relationship between the user account and the content source ID to the client terminal.

At 508, the second client terminal may receive, from the social application server, the information associated with the established relationship between the user account and the content source ID.

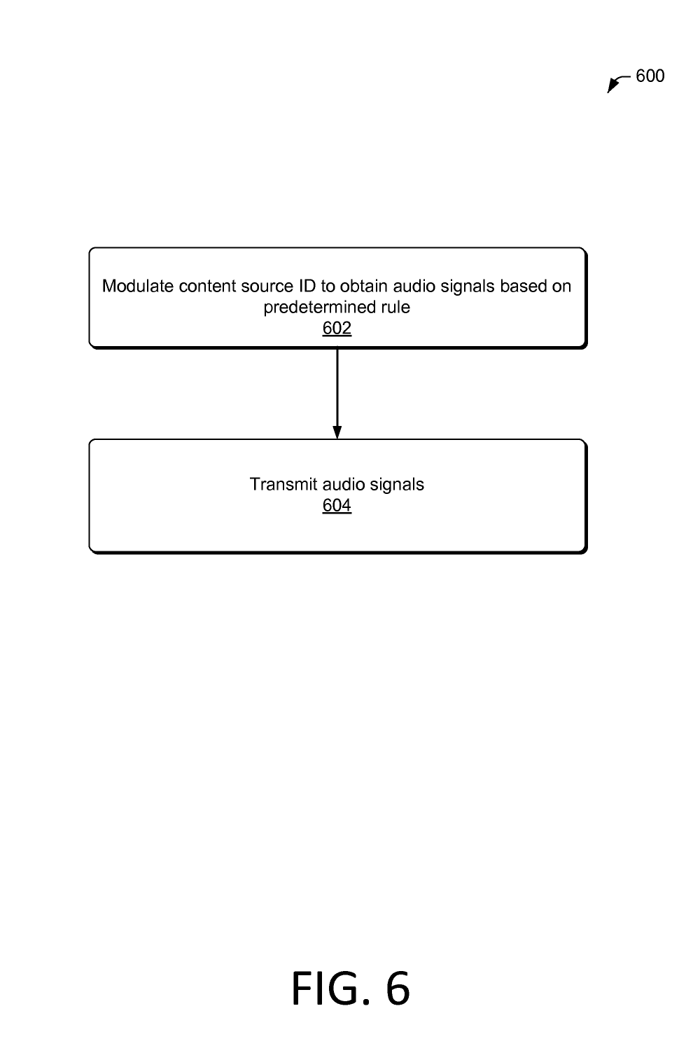

FIG. 6 is a flow chart of an illustrative process 600 for extending content sources. At 602, the first client terminal may modulate a content source ID to obtain audio signals based on a predetermined rule. The first client terminal may convert the content source ID to a certain audio signals. For example, the conversion may be implemented based on a predetermined rule.

In implementations, the first client terminal may modulate the content source ID to obtain an ASCII code. The first client terminal may convert the ASCII code into audio signals. For example, each character corresponds to a unique ASCII code. Each ASCII code may correspond to a combination of a certain number of frequency bands, and each frequency segment has a predetermined length of time. For example, an ASCII code “4EBA” corresponds to a Chinese character “person”. According to the above rules, the ASCII code may correspond to: the core frequency of 50 Hz, duration of 50 ms frequency band a, the core frequency of 165 Hz, duration of 50 ms frequency band b, the core frequency of 2.34 KHz, duration of 50 ms frequency band c, and the core frequency of 19 KHz, duration of 50 ms frequency band d. A combination of frequency bands a-d represents an ASCII code “4EBA.”

Accordingly, the first client terminal may convert the content source ID to a certain audio signals. The content source ID may be an account associated with the first client terminal or an account associated with other content sources. The content source ID may include a personal user account, a public service party service provider account, or a business account.

At 604, the first client terminal may transmit the audio signals. The client first terminal may broadcast the mapped audio signals via speakers. In implementations, two mobile terminals may be added each other for content sources by facing to facing. Of course, it is appreciated that implementations may apply to other situations. Through the implementations, a user on the client terminal may not need complex operations to extend content sources. This improves convenience of extending content sources.

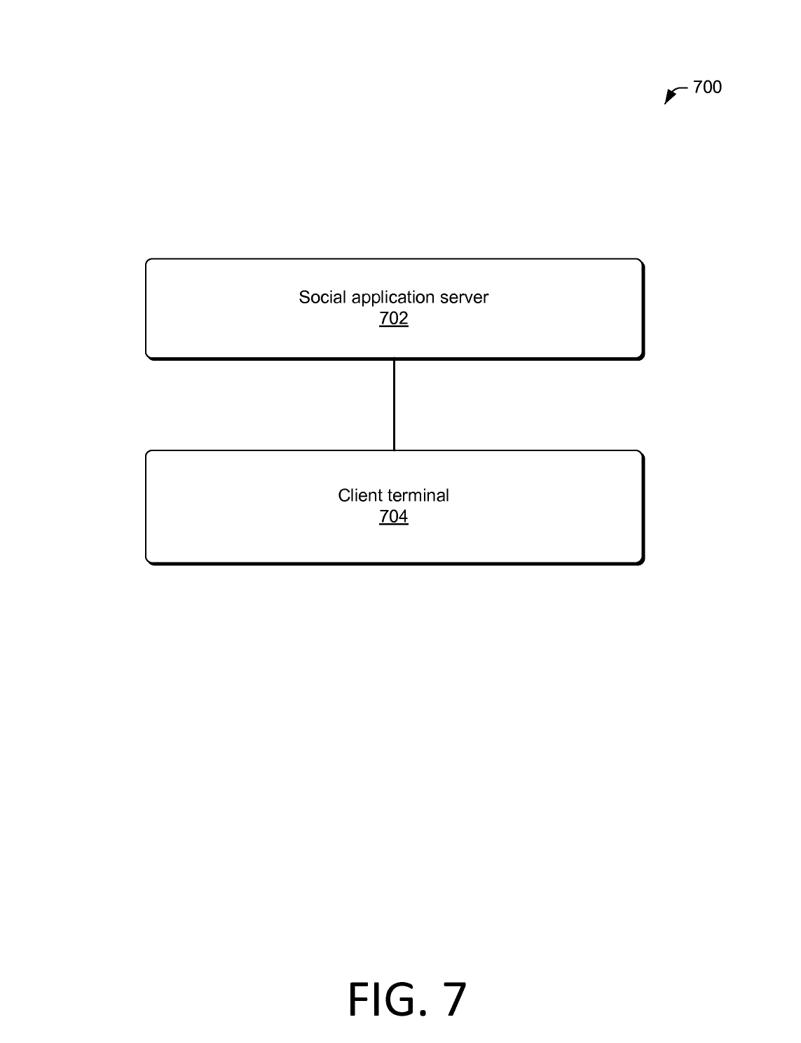

FIG. 7 is a schematic diagram of illustrative computing architecture 700 that enables extending content sources. The computing architecture 700 includes a social application server 702 and a client terminal 704. The client terminal 704 may sample as well as quantify audio signals and encode the sampled and quantified audio signals based on a predetermined encoding rule to generate a digital audio content. The client terminal 704 may transmit the digital audio content and a user account to a social application server, to transmit an instruction to establish a relationship between the user account and a content source ID corresponding to the digital audio content, and to receive, from the social application server 702, information associated with the established relationship between the user account and the content source ID.

The social application server 702 may receive, from the client terminal 704, a digital audio content and a user account associated with the client terminal and match the received digital audio content with a stored digital audio content. In response to a determination that the received digital audio content matches the stored digital audio content, the social application server 702 may establish a relationship between the user account associated with the client terminal and the content source ID corresponding to the stored digital audio content based on a predetermined correspondence between the stored digital content and a content source ID.

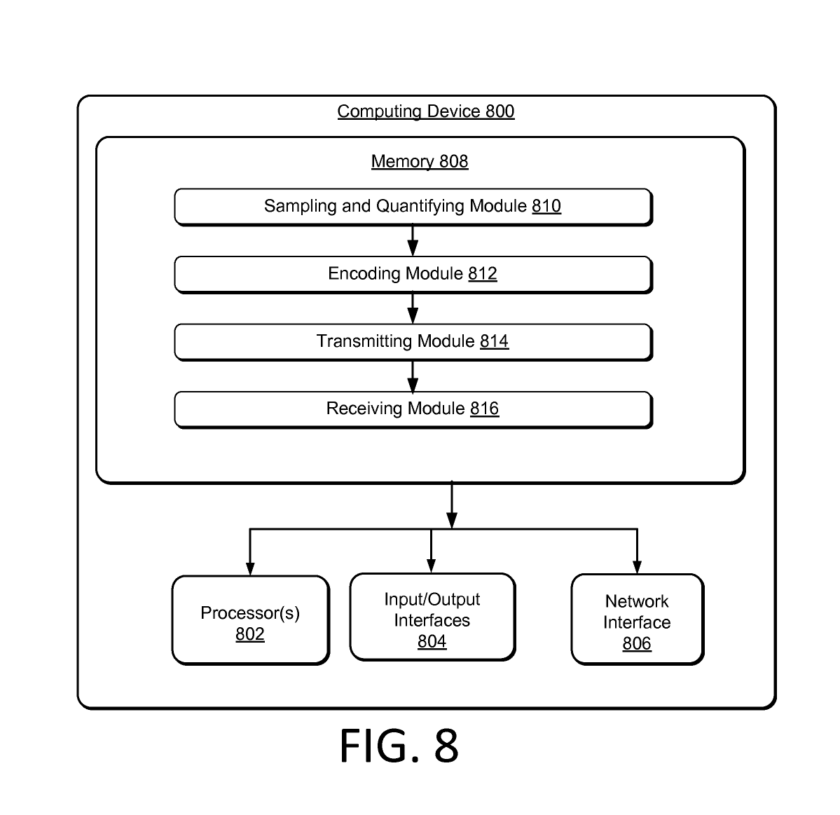

FIG. 8 is a schematic diagram of illustrative computing architecture 800 that enables extending content sources on a client terminal. The computing architecture 800 may be a user device or a server for extending content sources. In an exemplary configuration, the computing device 800 includes one or more processors 802, input/output interfaces 804, network interface 806, and memory 808.

The memory 808 may include computer-readable media in the form of volatile memory, such as random-access memory (RAM) and/or non-volatile memory, such as read only memory (ROM) or flash RAM. The memory 808 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 808 in more detail, the memory 808 may include a sampling and quantifying module 810, an encoding module 812, a transmitting module 814, and a receiving module 816. The sampling and quantifying module 810 may sample and quantify audio signals. The encoding module 812 may encode the sampled and quantified audio signals based on a predetermined encoding rule to generate a digital audio content. The transmitting module 814 may transmit the digital audio content and a user account to a social application server, and transmit an instruction to establish a relationship between the user account and a content source ID corresponding to the digital audio content.

The receiving module 816 may receive, from the social application server, information associated with the established relationship between the user account and the content source ID. The sampling and quantifying module 801 may include a microphone. The client terminal may sample and quantify the audio content, which is longer than a first predetermined period of time.

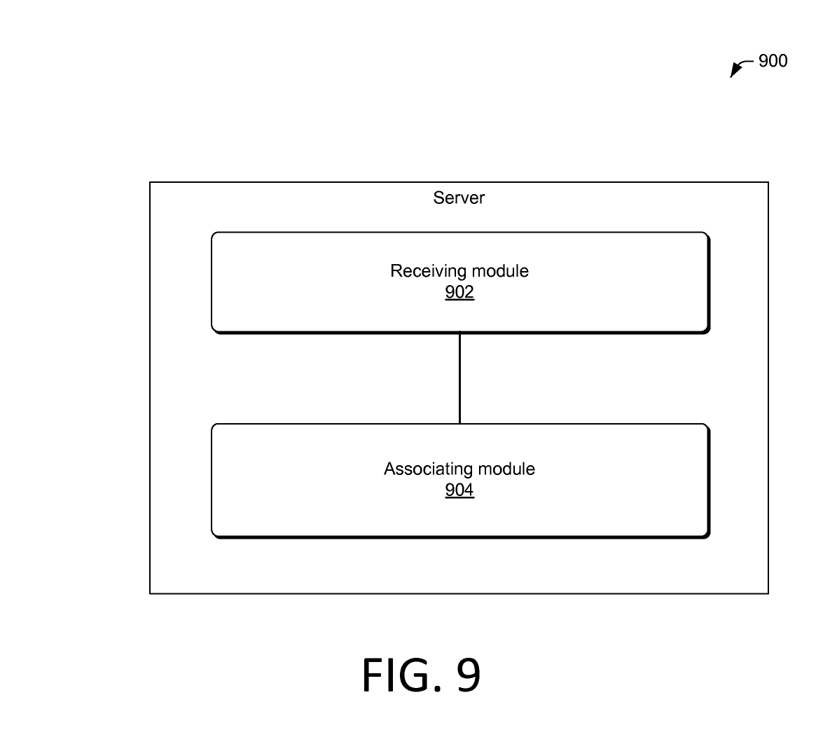

FIG. 9 is a schematic diagram of illustrative computing architecture 900 that enables extending content sources on a server terminal. The computing architecture 900 includes a server. The server may include one or more processors, input/output interfaces, network interface, and memory. The memory may include a receiving module 902 and an associating module 904.

The receiving module 902 may receive, from a client terminal, a digital audio content and a user account associated with the client terminal. The associating module 904 may match the received digital audio content with a stored digital audio content. In response to a determination that the received digital audio content matches the stored digital audio content, the associating module 904 may establish a relationship between the user account associated with the client terminal and the content source ID corresponding to the stored digital audio content based on a predetermined correspondence between the stored digital content and a content source ID.

Implementations herein also relate to a system for extending content sources. The system may include a client terminal and a server. The client terminal may sample and quantify audio signals and encode the sampled and quantified audio signals based on a predetermined encoding rule to generate a digital audio content. The client terminal may transmit the digital audio content and a user account to a social application server and transmit an instruction to establish a relationship between the user account and a content source ID corresponding to the digital audio content. The client terminal may receive, from the server, information associated with the established relationship between the user account and the content source ID.

The server may receive, from the client terminal, a digital audio content and a user account associated with the client terminal and may match the received digital audio content with a stored digital audio content. In response to a determination that the received digital audio content matches a stored digital audio content, the server may establish a relationship between the user account associated with the client terminal and the content source ID corresponding to the stored digital audio content.

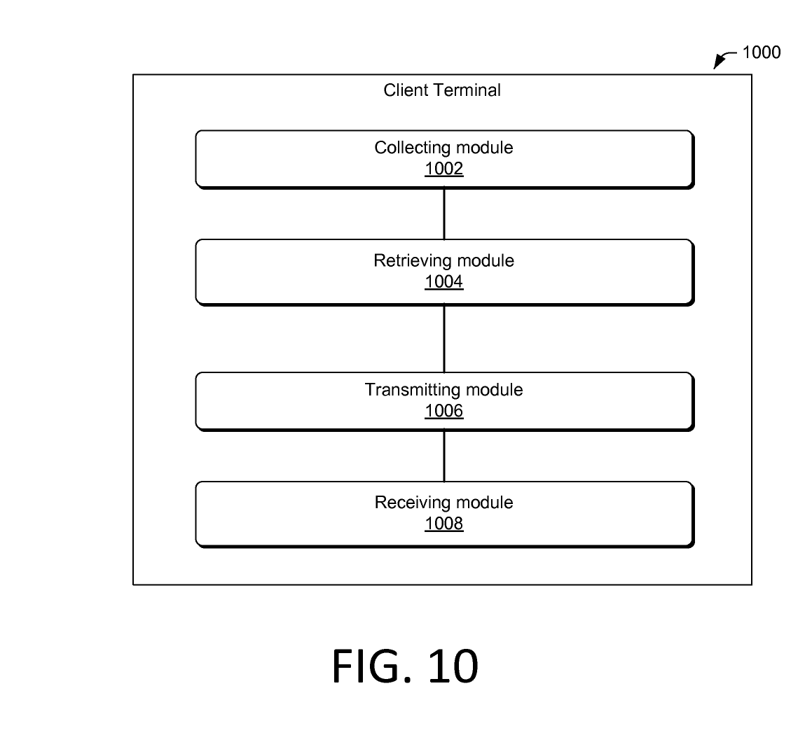

FIG. 10 is a schematic diagram of illustrative computing architecture 1000 that enables extending content sources on a server terminal. The computing architecture 1000 includes a client terminal. The client terminal may include one or more processors, input/output interfaces, network interface, and memory. The memory may include a collecting module 1002, a retrieving module 1004, a transmitting module 1006, and a receiving module 1008.

The collecting module 1002 may sample audio signals. The retrieving module 1004 may retrieve a feature from the audio signals. The transmitting module 1006 may transmit the feature and a user account to a social application server and transmit an instruction to establish a relationship between the user account and a content source ID corresponding to the digital audio content. The receiving module 1008 may receive, from a server, information associated with the established relationship between the user account and the content source ID of the feature. The feature may include a feature of a time domain or a frequency domain of the audio signals, or a combination thereof.

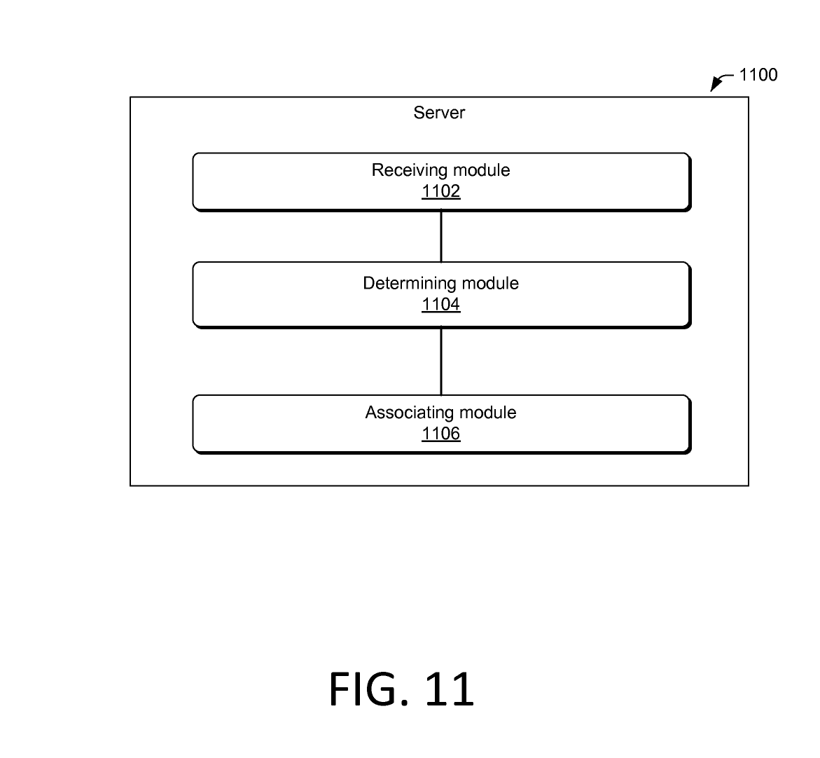

FIG. 11 is a schematic diagram of illustrative computing architecture 1100 that enables extending content sources on a server terminal. The computing architecture 1100 includes a server. The server may include one or more processors, input/output interfaces, network interface, and memory. The memory may include a receiving module 1102, a determining module 1104, and an associating module 1106.

The receiving module 1102 may receive, from a client terminal, a feature and a user account associated with the client terminal. The determining module 1104 determine the content source ID corresponding to the feature based on a mapping relationship between a stored feature and a content source ID. The relationship module 1106 establish a relationship between the user account associated with the client terminal and the content source ID. The stored feature is generated based on the content source ID that is received by the social application server from the content source side and is modulated based on a predetermined rule.

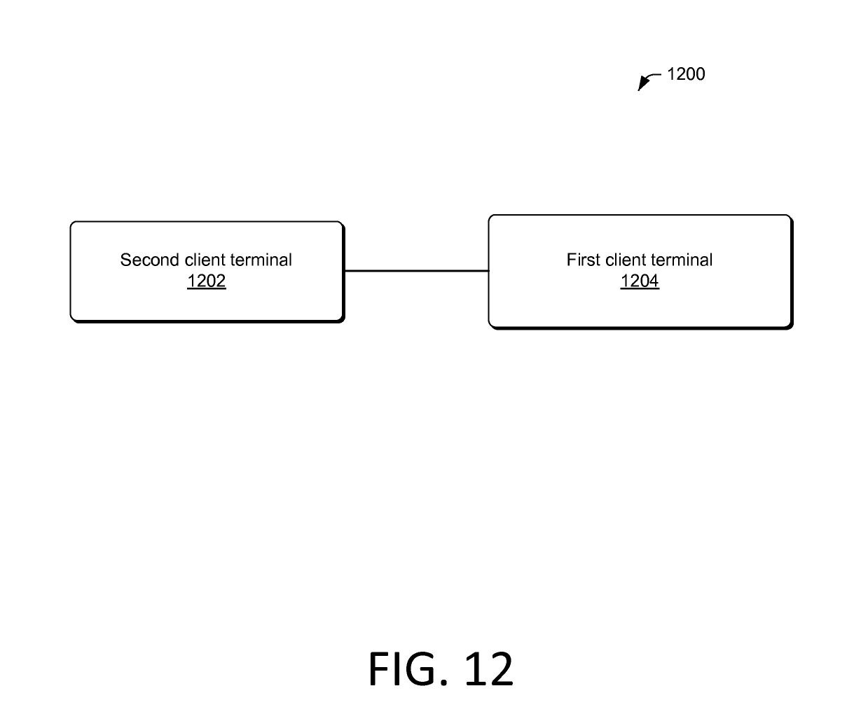

FIG. 12 is a schematic diagram of illustrative computing architecture 1200 that enables extending content sources. The computing architecture 1200 includes a first client terminal 1204 and a second client terminal 1202.

The second client terminal 1202 may collect modulated audio signals based on a content source ID of a content source side and demodulate the collected audio signals to obtain the content source ID based on a predetermined rule. The second client terminal 1202 may transmit the content source ID and a user account to a social application server and may receive, from a server, information associated with the established relationship between the user account of the second terminal client and the content source ID. The first client terminal 1204 may modulate a content source ID to obtain audio signals based on a predetermined rule and may transmit the modulated audio signals.

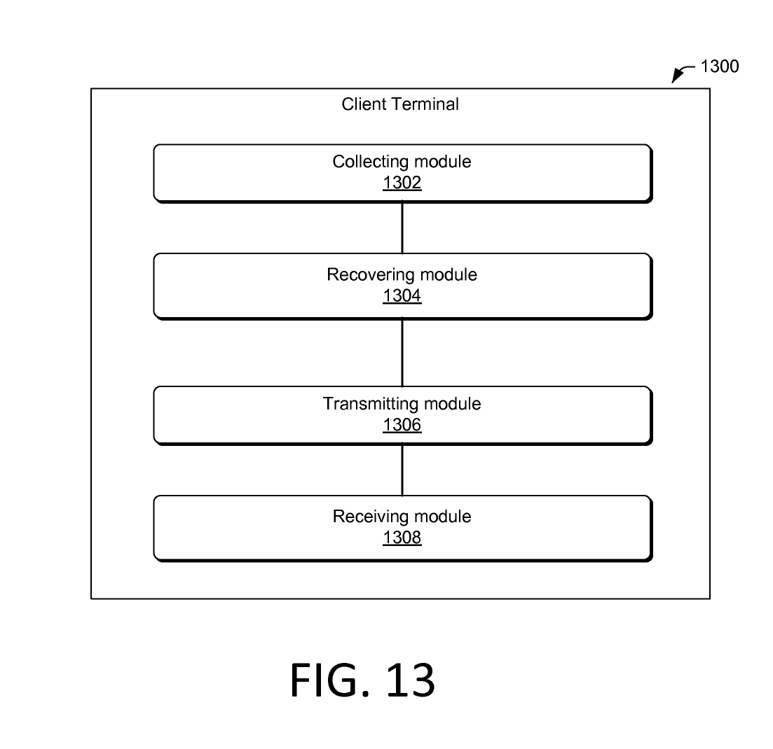

FIG. 13 is a schematic diagram of illustrative computing architecture 1300 that enables extending content sources on a server terminal. The computing architecture 1300 includes a client terminal. The client terminal may include one or more processors, input/output interfaces, network interface, and memory. The memory may include a collecting module 1302, a recovering module 1304, a transmitting module 1306, and a receiving module 1308.

The collecting module 1302 may collect modulated audio signals based on a content source ID of a content source side. The recovering module 1304 demodulate the collected audio signals to obtain the content source ID based on a predetermined rule. The transmitting module 1306 may transmit the content source ID and a user account to a social application server. The receiving module 1308 may receive, from the social application server, information associated with the established relationship between the user account and the content source ID. The recovering module 1304 may further include a demodulating module configured to demodulate the collected audio signals to obtain an ASCII code, and a converting module configured to convert the ASCII code to a content source ID.

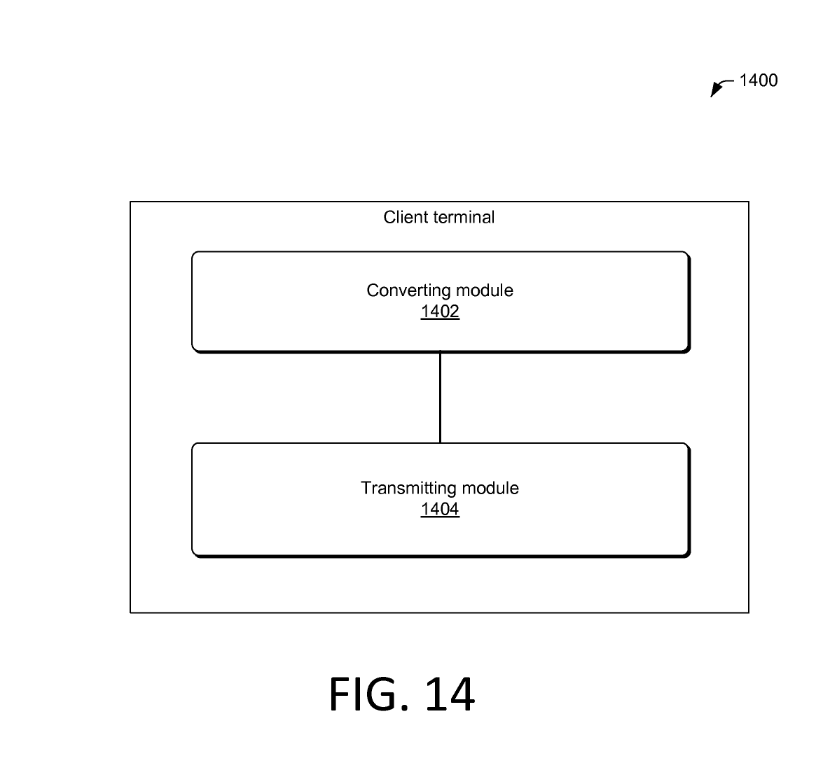

FIG. 14 is a schematic diagram of illustrative computing architecture 1400 that enables extending content sources on a server terminal. The computing architecture 1400 includes a client terminal. The client terminal may include one or more processors, input/output interfaces, network interface, and memory. The memory may include a converting module 1402 and a transmitting module 1404.

The converting module 1402 may modulate a content source ID to obtain audio signals based on a predetermined rule. The transmitting module 1404 may transmit the audio signals. The converting module 1402 may include a first converting module configured to modulate the content source ID to obtain an ASCII code, and a second converting module configured to convert the ASCII code into audio signals.

The above implementations are described using a progressive manner, and the same or similar parts of various implementations can be references to each other.

In the 1990s, technique improvements can be clearly distinguished with respect to the improvements on hardware (e.g., diodes, transistors, switches and other circuit structure) or improvements on software. However, with technology development, many improved process flows can be seen as a direct hardware circuit configuration. Designers generally program improved process flows into hardware circuits to get a corresponding improvement on hardware circuit structures. Therefore, it is true that improving process flows can be achieved using a hardware entity module. For example, a programmable logic device (Programmable Logic Device, PLD) (e.g., Field Programmable Gate Array, FPGA) is one such integrated circuit logic functions performed and determined by a user to program devices.

Programmed by the designer, a digital system is “integrated” in the midst of PLD without manufacturer's designs and productions of specialized integrated circuit chips. And now, in addition to replacing manually produced integrated circuit chip, programs are also replaced by “logic compiler” software. Similar to software compiler, such logic compiler compiles the original codes written in a specific programming language. This is called a hardware description language (HDL). HDL is not the only one, and there are many kinds, such as Advanced Boolean Expression Language (ABEL), Altera Hardware Description Language (AHDL), Confluence, Cornell University Programming Language (CUPL), HDCaI, Java Hardware Description Language (JHDL), Lava, Lola, MyHDL, PALASM, Ruby Hardware Description Language (RHDL), etc. The most commonly ones are Very-High-Speed Integrated Circuit Hardware Description Language (VHDL) and Verilog 2.

Those skilled in the art should be clear that a logic method flow may be achieved in hardware circuits by using several methods of hardware description languages, performing a little logic programming, and/or compiling into an integrated circuit.

A controller can be realized in any suitable manners. For example, the controller can be implemented using a microprocessor or processor and a memory such as a computer readable program code executed by a processor, a computer readable medium, logic gates, switches, an application specific integrated circuit (ASIC), programmable logic controllers, and embedded microcontroller form. Examples of controllers include, but are not limited to, the following microcontrollers: ARC 625D, Atmel AT91SAM, Microchip PIC18F26K20 and Silicone Labs C8051F320. The memory controller can also be implemented as part of the control logic of the memory.

Those skilled in the art also know that there are other methods implementing the controller in addition to pure computer readable program codes. The methods may program to control logic gates, switches, in the form of application specific integrated circuits, programmable logic controllers and embedded microcontrollers. Therefore, the controller may be considered to be a hardware component, and may include modules for implementing various functions and be considered as a part of hardware structures. Therefore a system or apparatus may be considered as software modules and/or hardware structures.

Systems, apparatuses, modules or units of the above-described implementations may be implemented by a computer chip or entity. For convenience of description, the description of the above devices and/or functions are divided into various modules. Of course, the functions of the modules can be implemented in one or more of software and/or hardware.

The implementations are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A computer-implemented method for extending content sources, the method comprising:
sampling and quantifying, by one or more processors of a computing device, audio signals;
encoding, by the one or more processors, the sampled and quantified audio signals to generate a digital audio content;
transmitting, by the one or more processors, the digital audio content and a user account associated with the computing device to a server,
transmitting, by the one or more processors, an instruction to the server to establish a relationship between the user account and a content source identifier (ID) corresponding to the digital audio content; and
receiving, by the one or more processors, information associated with the established relationship between the user account and the content source ID from the server.

2. The method of claim 1, wherein the content source ID comprises at least one of a personal user account, a public service provider account, or a business account.

3. The method of claim 1, wherein the sampling the audio signals comprises sampling audio signals between 20 Hz to 20 kHz from the audio signals.

4. A computer-implemented method for extending content sources, the method comprising:
receiving, by one or more processors of a server, a digital audio content and a user account associated with a client terminal;
matching, by the one or more processors, the received digital audio content with a stored digital audio content; and
in response to a determination that the received digital audio content matches the stored digital audio content, establishing, by the one or more processors, a relationship between the user account associated with the client terminal and a content source ID corresponding to the stored digital audio content based on a predetermined correspondence between the stored digital content and the content source ID.

5. The method of claim 4, wherein the matching the received digital audio content with the stored digital audio content comprises determining that the received digital audio content matches the stored digital audio content when the received digital audio content is a subset of the stored digital audio content.

6. The method of claim 5, wherein the determining that the received digital audio content matches the stored digital audio content when the received digital audio content is the subset of the stored digital audio content comprises determining that the received digital audio content matches the stored digital audio content when a proper subset of the received digital audio content is the subset of the stored digital audio content, and wherein a length of the proper subset is not less than a predetermined length.

7. The method of claim 4, wherein the matching the received digital audio content with the stored digital audio content comprises determining that the received digital audio content matches the stored digital audio content when the received digital audio content is a subset of a cycle focus of the stored digital audio content.

8. The method of claim 4, further comprising:
storing the digital audio content and the content source ID at the server,

9. The method of claim 8, further comprising:
generating the stored digital audio content based on the received content source ID from a content source side.

10. The method of claim 4, further comprising:
adding the content source ID corresponding the digital audio content to a social relationship list of a social account associated with the client terminal.

11. The method of claim 4, further comprising:
transmitting to the client terminal the established relationship between the user account associated with the client terminal and the content source ID corresponding to the stored digital audio content.

12. A computer-implemented method for extending content sources, the method comprising:
sampling, by one or more processors of a computing device, audio signals;
retrieving, by the one or more processors, a feature from the audio signals;
transmitting, by the one or more processors, the feature and a user account associated with the computing device to a server;
transmitting, by the one or more processors, an instruction to the server to establish a relationship between the user account and a content source ID corresponding to the feature; and
receiving, by the one or more processors, information associated with the established relationship between the user account and the content source ID of the feature from the server.

13. The method of claim 12, wherein the feature comprises a feature of a time domain or a frequency domain of the audio signals, or a combination thereof.

14. The method of claim 12, wherein the feature comprises a melody feature of the audio signals.

15. The method of claim 12, wherein the content source ID comprises at least one of a personal user account, a public service provider account, or a business account.

16. The method of claim 12, further comprising:
receiving, by the server, the feature and the user account associated with the computing device;
determining, by the server, the content source ID corresponding to the feature based on a mapping relationship between a stored feature and the content source ID; and
establishing, by the server, a relationship between the user account associated with the client terminal and the content source ID;

17. The method of claim 16, further comprising:
storing the relationship between the stored feature and the content source ID on the server,

18. The method of claim 16, further comprising:
generating the stored feature based on the received digital audio content from a content source side.

19. The method of claim 16, wherein further comprising:
adding the content source ID corresponding the feature to a social relationship list of a social account on the computing device.

20. The method of claim 16, further comprising:
transmitting the established relationship between the user account associated with the computing device and the content source ID corresponding to the stored feature.
